(19) United States
(12) Patent Application Publication
(10) Pub. No.: US 2003/0024981 A1
(43) Pub. Date: Feb. 6, 2003

(54) Automated coupon solution

(76) Inventor: Sangeetha Narasimhan, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/920,234

(22) Filed: Aug. 1, 2001

(51) Int. Cl. G06K 15/00

(52) U.S. Cl. 235/383

(57) ABSTRACT

A system and method is disclosed for automatically finding discount coupons on a data network. The preferred embodiment provides an automated coupon redemption unit comprising a code scanner for reading codes from a plurality of consumer items, a network interface for facilitating access to a data network, and a search algorithm for automatically searching said data network for coupons responsive to said codes.

### TECHNICAL FIELD

The invention relates in general to retail purchasing solutions and, in particular, to automatically searching a data network for available coupons based on a product code read by the system.

### BACKGROUND

In commercial industries many marketing techniques include the use of coupons, manufacturer's rebates, and promotional discounts. For purposes of this application, discount coupons include, not only coupons and discount media, but also manufacturer's or other rebates and certificates. Typically a customer will obtain a coupon from some source such as a newspaper, magazine, mailing, or other similar delivery mechanism. The customer generally gathers the coupons he or she desires to use and carries them to a store to redeem those coupons for products and/or services.

In the case of manufacturer's rebates, the customer typically receives a certificate at the time of purchase that requires the customer to fill in certain customer information, such as address, phone number, e-mail address, and sometimes other information related to the interests of the customer. Manufacturer's rebates also usually include space for providing information about the item or product purchased. This information may sometimes include model number, serial number, the name of the product, the store at which the product was purchased, and the like.

While such coupon-related marketing techniques typically increase sales for a given product, customers many times forget to bring coupons to a store, or fail to return completed certificates to the manufacturer or coupon sponsor to receive the rebate or discount. Thus many customers may purchase an item because of a particular coupon or rebate, yet fail to receive the benefit of the coupon or rebate because they fail to complete the necessary process.

Furthermore, a customer may generally only have access to a limited resource for coupons, discounts, rebates, and the like. With the advances of e-commerce using the Internet, there are several websites that specialize in gathering coupons, rebates, and the like. However, printing out the new “e-coupons” still requires the customer to remember to bring the coupons to the store and/or send the completed coupon or manufacturer's rebate to the manufacturer or coupon sponsor.

Organizers have been developed to make organizing and bringing coupons to a particular store more convenient. However, none of these organizers address the underlying problems of the customer remembering to bring the coupons or the coupon organizer to the appropriate stores. Furthermore, there are currently no methods available to organize or remind customers to mail in manufacturer's rebates or coupons or systems that facilitate searching and redeeming coupons at the point of sale. 4

### SUMMARY OF THE INVENTION

The present invention is directed to a system and method for automatically finding discount coupons on a data network. The preferred embodiment of the present invention provides an automated coupon redemption unit comprising a code scanner for reading codes from a plurality of consumer items, a network interface for facilitating access to a data network, and a search algorithm for searching said data network for coupons responsive to said codes.

### BRIEF DESCRIPTION OF THE DRAWING

FIG. 1 is a perspective view illustrating a preferred embodiment of the present invention configured at a check-out counter of a store;

FIG. 2 is a perspective view of an alternative embodiment of the present invention configured in a hand-held device; and

FIG. 3 is a flow chart presenting the steps performed in implementing a preferred embodiment of the present invention.

### DETAILED DESCRIPTION

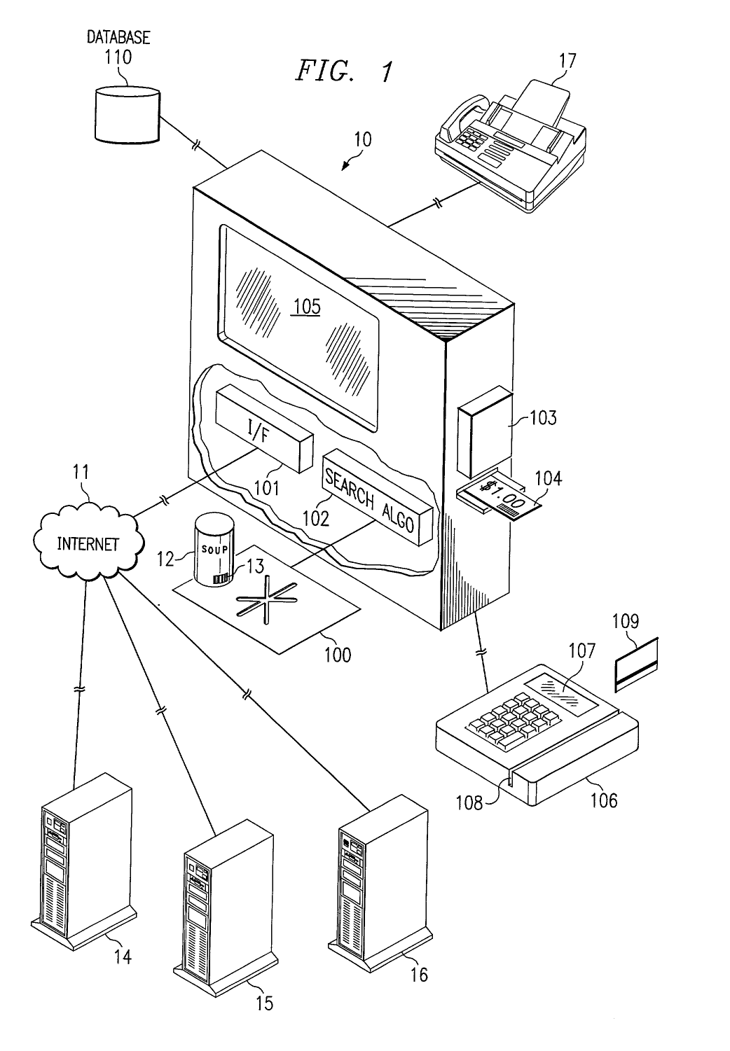

FIG. 1 is a perspective view of a preferred embodiment of the present invention configured as a part of a commercial check-out stand. Coupon unit 10 is preferably disposed conveniently at the check-out counter (not shown) of a typical store. Coupon unit 10 is also preferably located in close proximity to the cash register (not shown) at the check-out counter. Coupon unit 10 is preferably coupled for electronic communication with scanner 100. Coupon unit 10 further preferably comprises network interface 101 and search algorithm 102. Coupon unit 10 may also preferably include printer 103, which may be accessible to a customer, the checker, or both.

In operation, consumer item 12 is passed over scanner 100. Scanner 100 scans consumer item 12 to read code 13. Code 13 may be a proprietary code for determining price, location, stock quantity, or the like, or may be a universal code, such as a universal product code (UPC) for determining the appropriate information regarding consumer item 12. As scanner 100 reads code 13, code 13 is preferably communicated to search algorithm 102. Search algorithm 102 preferably signals to network interface 101 to automatically initiate a communication session with a data network such as Internet 11. The data network is not limited to only Internet 11, but may additionally or alternatively comprise a database singly incorporated into unit 10, a network of databases connected over a local area network (LAN), or the like. For example, databases incorporated into coupon unit 10 or connected over a LAN may preferably maintain coupons specifically tied to a particular store or group of stores connected with the database.

It should be noted that in alternative preferred embodiments of the present invention, coupon unit 10 may comprise a single, multi-function unit. Such an embodiment of coupon unit 10 would preferably incorporate scanner 100, network interface 101, search algorithm 102, printer 103, and any other communication means, such as a fax machine, into a single unit. Thus, any retail store would preferably only be required to purchase a single unit in order to implement the inventive method.

Returning to FIG. 1, once a communication session has been initiated, search algorithm 102 preferably performs a general or targeted search for any discount or product coupons, which may also include any manufacturer's rebates or discounts. Search algorithm 102 preferably searches through available relevant coupon data, such as may be accessed through servers 14 and 15, also connected to Internet 11, for such coupons. If any coupons are found residing on servers 14, 15, and/or other location on Internet 11, the coupons are preferably retrieved into coupon unit 10. Such coupons retrieved over Internet 11 may preferably be printed at printer 103. The customer may then preferably take printed coupon 104 and have the checker redeem the coupon at the point of sale. If the coupon or manufacturer's rebate requires any customer information to be added, the customer may manually write in such information as the checker continues checking the customer's items or may preferably use an available user interface, such as customer unit 106 described below.

Alternative embodiments of the present invention may also include customer unit 106 to provide a user interface for the customer. In such embodiments, as the coupons are retrieved from Internet 11, they are preferably displayed to the customer on customer display 107. The customer may then preferably choose the particular coupons or manufacturer's rebates he or she desires to use. Once the customer chooses the desired coupons, those selected coupons may preferably be printed on printer 103 for a user to physically redeem at the check-out stand, directly transmitted to an issuer or manufacturer via issuer's remote fax 17 and/or issuer's remote server 16, or automatically redeemed as the user purchases the associated products.

In further alternative embodiments, any customer information that is required by the coupon or the manufacturer's rebate may preferably be automatically filled in through the use of a customer card storing specific customer information or means for accessing such information stored on an accessible database. For example, many states now incorporate a magnetic strip, bar code, or the like on their driver's licenses that includes or facilitates access to data about the driver, such as name, address, phone number, and the like. Still other stores may provide fobs with a radio frequency (RF) signal that corresponds to a code tied to a particular user. Such a fob may be waived over a receiver and allow access to user information stored on a centralized server indexed by the user's RF frequency code. Also, some stores offer special club cards to individual customers wishing to receive added discounts or incentives for purchasing at the store. Such membership cards also typically provide access to such customer information, which may be stored on a merchant database or a third party database accessible by the merchant. The information stored in such a manner is accessible and may be indexed according to the information stored on the membership card.

Furthermore, some credit cards, which may comprise smart cards or cards with semiconductor devices built into the card, also contain user information or be connected to central servers that contain user or customer information. Smart cards may also comprise handheld devices or cards that provide RF signals, electromagnetic, optoelectronic, or similar signals for communicating information. As the customer proceeds with the check out process, the customer may swipe one of these information cards, such as member ID 109, through slot 108 of customer unit 106. As the information is read from member ID 109, it preferably is automatically placed in the appropriate places in the selected coupon. The user may then either print printed coupon 104 if necessary for redeeming with the coupon issuer or the completed coupon may either be electronically communicated for redemption directly with the coupon issuer or automatically redeemed at the point of sale.

Alternatively, if a user does not have member ID 109 for automatically processing the customer information, the user may alternatively enter customer information through customer unit 106, such as through the use of a keyboard or other conventional user interface. For example, a user may use a mouse, a stylus, or even a voice recognition unit to enter customer information to fill out the selected coupon.

In one embodiment of the alternative version, database 110 is preferably connected to coupon unit 10. As the user enters the customer information through customer unit 106, it is preferably stored in database 110. With such embodiments, the next time the same user goes through the store checkout, the customer information is preferably retrieved from database 110 and automatically entered into the appropriate discount coupon. These embodiments may also preferably incorporate the functionality of using the customer data stored on member ID 109. Thus, when the user swipes member ID 109 through slot 108 of customer unit 106, the customer information is also preferably stored on database 110 for future automated use.

In further such alterative versions, coupon unit 10 may preferably incorporate optical scanning technology allowing a user to swipe a regular drivers license or other form of identification which, through the further use of optical character recognition (OCR) applications, may preferably read the user's information directly from the identification card. This information may then preferably be used to fill-in the coupon and may also be stored for future automated use as described above.

Once the coupons have been found, retrieved with any required customer information added thereafter, the present invention preferably allows the customer to redeem the coupon at the point of sale in several different alternative ways depending on the requirements and capabilities of the coupon issuer.

If the coupon issuer merely requires a user to redeem the coupon at the cash register or check-out counter, the user may print the coupon and turn it over to the check-out clerk at the point of sale. If, however, the coupon issuer requires the user to directly send the coupon back to the issuer or to the manufacturer the present invention allows the user either to send the printed coupon, that may or may not have been filled out with user information if required, back to the issuer or manufacturer using U.S. mail or other postal carrier. Alternatively, if the coupon issuer or coupon redeemer is able to receive fax or electronic communications, the completed coupon may preferably be faxed or e-mailed to the coupon issuer or redeemer through communication interface 101 to issuer's remote fax 17 or issuer's remote server 16.

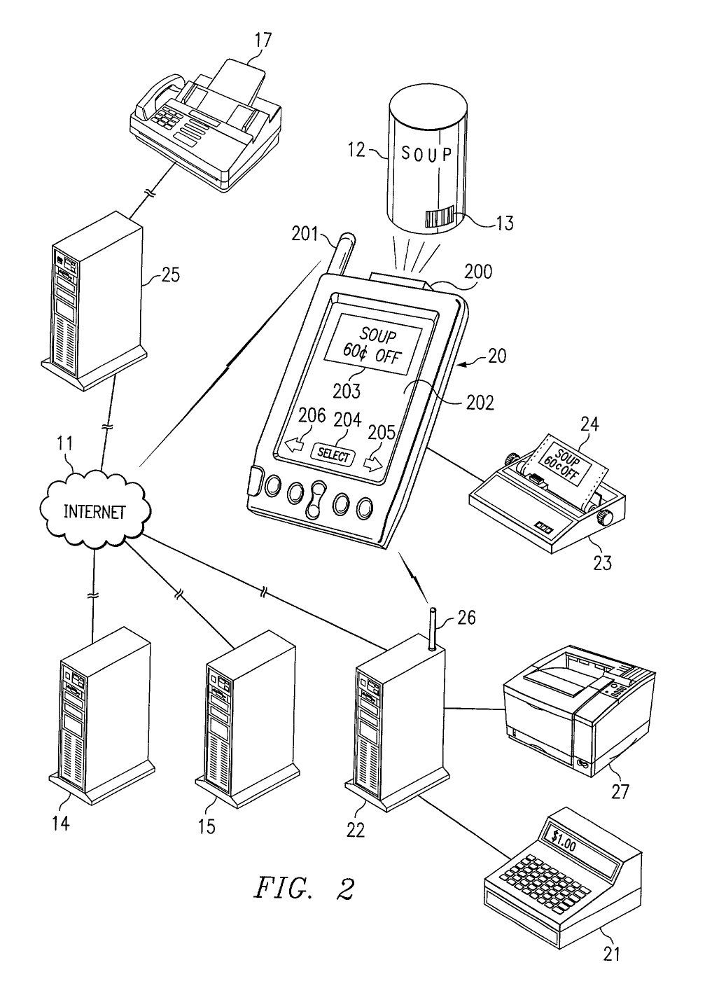

FIG. 2 illustrates an alternative embodiment of the present invention implemented into a handheld personal data assistant (PDA). In one such embodiment, instead of the store providing the service for finding and redeeming coupons, each customer may preferably independently have the capability of implementing the present invention as he or she walks through the store. PDA unit 20 preferably comprises scanner 200 for reading a UPC or similar code, such as code 13 of item 12. It also includes PDA display 202 for displaying the search results, such as displayed coupon 203, and antenna 201 for preferably facilitating wireless communication with a data network, such as Internet 11. It should be noted that PDA 20 may establish communication with Internet 11 either directly through a service subscribed to by the user, or communication may be facilitated by store server 22 connected to Internet 11.

In using the described alternative embodiment, when the user selects coupons, such as manufacturer's rebates, that require additional customer information to be filled out, PDA unit 20 may preferably automatically fill in such information from such customer information stored on PDA unit 20. Thus, as the selected coupons are communicated, PDA unit 20 will automatically fill in any customer information required by the particular coupon. The user may also have a choice to fill out any coupons manually, if desired. Thereafter, by using a portable printer, such as portable printer 23, the user may then preferably print printed coupon 24 to redeem at the store's check-out counter during the sale.

It should be noted that PDA unit 20 may preferably be configured to communicate with Internet 11 and/or store server 22 through one of the many known wireless formats, such as infrared (IR), BLUETOOTH (TM), IEEE 802.11, and the like.

In a further alternative embodiment shown in FIG. 2, the store may beneficially provide means for facilitating and assisting with the automated coupon service. In such an embodiment, the store may preferably provide central printer 27 on which users may print coupons required by the issuer to be printed and redeemed at the check-out counter. As the user shops, he or she may preferably scan a UPC or similar code, such as code 13 on item 12. Using code 13, PDA unit 20 establishes communication with Internet 11 to search through available relevant coupon data, such as may be accessed through coupon servers 14 and 15. Each coupon found is thereafter retrieved and displayed to the user on PDA display 202. The user views displayed coupon 203 and uses selection option 204 to select ones of displayed coupon 203. In order to view other retrieved coupons, the user would preferably actuate navigation options 205 and 206.

Once the user selects the desired coupons to use, he or she may preferably send the selected coupons to store server 22 using a wireless connection facilitated between antenna 201 of PDA 20 and antenna 26 of store server 22 or a wireline connection to store server 22. Depending on the type of coupons selected or on the user's preference, store server 22 may preferably either: (1) send the coupons directly to cash register 21 for automatic electronic redemption when the user is checking out; (2) send the coupons to central printer 27 when the user selects to print them; (3) send the coupons directly to the coupon issuer for redemption; (4) or any combination thereof. Therefore, after selecting the desired coupons, the user may go to central printer 27 and select to print out the coupons that need to be physically redeemed at cash register 21.

In order to prevent other individuals from printing out the user's selected coupons, a code may preferably be provided for the user to either manually enter into central printer 27, or that may be digitally placed onto PDA 20 and then communicated to central printer 27. The user's selected coupons would preferably be placed in storage in store server 22 until called up by central printer 27 after receiving the appropriate code from the user or PDA 20. Similarly, as the user enters one of the store's check-out counters, the user's code may preferably be entered into cash register 21, either manually or through PDA 20, in order to signal store server 22 to communicate the user's coupons for immediate redemption directly to cash register 21.

It should be noted that in order to prevent improper redemption for coupons when the user does not purchase the corresponding product, logic may be implemented to allow automated redemption only when the UPC code connected with the coupon matches a UPC code of a product purchased by the user. Similarly, for coupons that the user must physically redeem at cash register 21 or that are to be sent directly to the manufacturer or issuer for redemption, the implemented logic may also compare the UPC codes for all types of the coupons to the products actually purchased. When the logic detects appropriate matches, the coupons are redeemed and/or communicated to the manufacturer or issuer. For all coupons that do not match, the logic may preferably alert the store clerk and/or the user of the missing products. The notification may preferably serve as a reminder to the user to purchase the actual product for which the coupon was selected. Alternatively, the user may request the unused coupons to be saved in store server 22, communicated back to be saved on PDA 20, or printed out for future use.

Alternatively, in stores equipped with such technology, the user may communicate all selected coupons to cash register 21 for redemption when user is checked out. Therefore, as the user selects different coupons for different consumer items, the appropriate coupons are preferably transmitted and stored according to the user's identity at cash register 21. When the user goes to check out of the store, the user may enter a code or swipe a specific card to indicate his or her identity. Once cash register 21 identifies the customer, all of the selected and communicated coupons are preferably either automatically redeemed or printed out at cash register 21 by an attached printer (not shown) or built-in printer (not shown), such as the receipt printer for cash register 21.

In a further alternative embodiment of the present invention configured in a personal unit, such as PDA unit 20, a third party may preferably provide such a coupon search and redemption service at a centralized server, such as central server 25, to control the searching and facilitate the communication of the selected and completed coupons to any necessary coupon provider. In such an embodiment, for all coupons requiring direct redemption with the manufacturer or coupon sponsor, PDA unit 20 preferably communicates the completed coupons to central server 25. From central server 25, the completed coupon may be forwarded to the appropriate manufacturer or coupon issuer, such as through fax 17. Similarly, if coupon sponsors include electronic access capabilities, the completed coupons could preferably be electronically communicated to these issuers through issuer server 16 (FIG. 1).

It should be noted that further alternative embodiments may combine different elements from one or more of the embodiments described herein. For example, in one such alternative embodiment, a store may provide a centralized printer, such as central printer 27 for customers to print the selected coupons. However, the store would not provide any further assistance with regard to either searching for or redeeming the selected couponse.

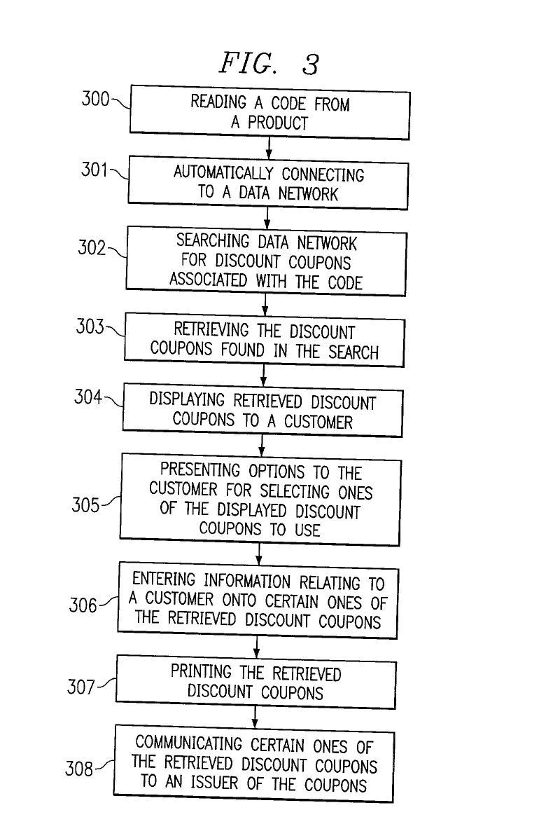

The flowchart depicted in FIG. 3 provides the steps used in implementing the preferred embodiment of the present invention. In step 300, a code is read from a product. As the code is read, a connection is preferably automatically established, in step 301, with a data network, such as the Internet. In step 302, the data network is preferably searched for discount coupons associated with the code. Once such discount coupons are found on the data network, they are preferably retrieved in step 303. The retrieved discount coupons are then preferably displayed to the customer in step 304. The customer may then select which of the retrieved discount coupons to use in step 305. In step 306, the customer may preferably enter information about him- or herself as required by certain ones of the retrieved discount coupons. Once any customer information has been entered, the retrieved discount coupons are preferably printed in step 307. In some circumstances, the customer may be required to redeem the coupons, which include manufacturer's rebates, directly with the manufacturer or issuer of the coupons. Therefore, in step 308, these certain ones of the retrieved discount coupons are communicated to the issuer thereof. Such communication may preferably comprise facsimile, e-mail, regular mail, and the like.

What is claimed is:

1. An automated coupon redemption unit comprising:
a code scanner for reading codes from a plurality of consumer items;
a network interface for facilitating access to a data network; and
a search algorithm for automatically searching said data network for coupons responsive to said codes.

2. The automated coupon redemption unit of claim 1 further comprising:
a printer for printing ones of said coupons found on said data network.

3. The automated coupon redemption unit of claim 1 further comprising:
a user interface for receiving customer information for filling out ones of said coupons.

4. The automated coupon redemption unit of claim 1 further comprising;
a database for storing at least one set of customer information for automatically filling out ones of said coupons.

5. The automated coupon redemption unit of claim 1 further comprising:
a device for reading customer information from a plurality of storage media.

6. The automated coupon redemption unit of claim 5 wherein said storage media comprises at least one of:
a magnetically encoded identification card;
a credit card;
a smart card; and
a bar code.

7. The automated coupon redemption unit of claim 1 further comprising:
a display for presenting ones of said coupons to a customer.

8. The automated coupon redemption unit of claim 7 further comprising:
a selection algorithm allowing said customer to selectively choose ones of said coupons for use.

9. The automated coupon redemption unit of claim 1 further comprising:
a data communication device for automatically communicating ones of said coupons to corresponding coupon issuers.

10. The automated coupon redemption unit of claim 1 further comprising logic for matching said coupons to purchased products prior to redemption of said coupon at a point of sale.

11. The automated coupon redemption unit of claim 10 wherein said coupons are automatically redeemed at said point of sale when said coupons match said purchased products.

12. A method for automatically locating discount coupons comprising the steps of:
reading a code from a product;
automatically connecting to a data network;
automatically searching said data network for said discount coupons associated with said code; and
retrieving said discount coupons resulting from said searching step.

13. The method of claim 12 further comprising the step of:
printing said retrieved discount coupons.

14. The method of claim 12 further comprising the step of:
entering information relating to a customer onto ones of said retrieved discount coupons.

15. The method of claim 12 further comprising the step of:
automatically filling ones of said retrieved discount coupons with information relating to a customer.

16. The method of claim 12 further comprising the step of:
displaying said retrieved discount coupons to a customer.

17. The method of claim 16 further comprising the step of:
presenting options to a customer for selecting ones of said displayed discount coupons.

18. The method of claim 12 further comprising the step of:
communicating ones of said retrieved discount coupons to an issuer of said discount coupons.

19. A system for automatically finding product coupons comprising:
means for scanning a UPC code from a product;
means for automatically communicating with the Internet;
means for automatically searching said Internet for said product coupons related to said UPC code; and
means for printing said coupons.

20. The system of claim 19 further comprising:
means for conveying said coupons to a coupon sponsor.
